(19) United States
(12) Patent Application Publication
(10) Pub. No.: US 2014/0031024 A1
(43) Pub. Date: Jan. 30, 2014

(54) Method and system for providing controllable trusted service manager

(71) Applicant: RFCyber Corporation, Fremont, CA (US)

(72) Inventors: Xiangzhen Xie, Shenzhen (CN); Liang Seng Koh, Fremont, CA (US); Hsin Pan, Fremont, CA (US)

(73) Assignee: RFCyber Corporation, Fremont, CA (US)

(21) Appl. No.: 14/037,203

(22) Filed: Sep. 25, 2013

Related U.S. Application Data
(63) Continuation-in-part of application No. 13/749,696, filed on Jan. 25, 2013.
(60) Provisional application No. 61/707,653, filed on Sep. 28, 2012.
(60) Provisional application No. 61/595,137, filed on Feb. 5, 2012.

(51) Int. Cl. H04W 12/08

(52) U.S. Cl. CPC H04W 12/08
USPC 455/418

(57) ABSTRACT

Techniques for realizing or providing controllable trusted service management are disclosed. The techniques are related to empowering a service provider with application provisioning and applet and secure element (SE) management capabilities. A service management module, herein referred to as Controllable TSM or CTSM, is provided to a service provider to provision certain applications distributed through the service provider. A system or platform contemplated in this invention allows a service provider to operate under a supplementary security domain (SSD) installed by an SE issuer or an updated SSD key set exclusively known to the service provider. Such a platform is designed to support embedded SE (eSE) and can be extended to support UICC-based SE. With the CTSM, a service provider can use the SSD to personalize applets installed on each SE securely and independently.

### BACKGROUND OF THE INVENTION

1. Field of the Invention

The present invention is generally related to the area of electronic commerce. Particularly, the present invention is related to trusted service management that may be controlled by an entity (e.g., a service provider), where the trusted service management is provided to facilitate the electronic commerce, particularly mobile commence, to take place with or without Internet access. More particularly, an embodiment of the trusted service management in the present invention enables a business operation to provide such a trusted service management to support various mobile applications provided or distributed by the business entity.

2. The Background of Related Art

One model that can address the business and operational requirements for the successful mass deployment of mobile payment is to use an intermediary—a Trusted Service Manager (TSM). This approach, endorsed by the GSMA (GSM Association), has the significant advantage of rapid scalability. The main role envisaged for the TSM is to help service providers securely distribute and manage contactless services for their customers using the networks of mobile operators. However, the TSM does not participate in actual contactless transactions using near-field communication (NFC) devices. These transactions are processed normally in whatever system the service provider and its merchant partners have already put in place. Another possible role of the TSM that can accelerate the successful deployment and ramp-up of mobile NFC applications is to act as a commercial intermediary that facilitates contractual arrangements and other aspects of ongoing business relationships between service providers and mobile operators.

A key element of the TSM role as envisioned by the GSMA is that it is an independent entity serving mobile network operators (MNOs) and any account-issuing entities such as banks, card associations, transit authorities, merchants and marketing companies, to name a few potential service providers. Thus an independent TSM is the key to the provisioning of applications to NFC-enabled phones such that they have the broadest possible purchasing power for the consumer. However, it does not seem always the case when the TSM is deployed.

For instance, it is conceivable that a bank working in conjunction with one of the major card associations could issue a phone through a major mobile network operator that is essentially a card association-branded phone. The card association or the bank might provide the TSM services for that one device. Such a partnership might resist adding merchant-specific prepaid accounts to those phones, because these accounts represent ways for consumers to make purchases without using the payment network of the card association. While the card association might think this is a good strategy for its own interests, it actually limits the commerce potential of those phones by excluding accounts that make it easier for consumers to make their buying decisions. Those phones, then, become less valuable to the entire mobile commerce ecosystem. They would be used for fewer transactions than might otherwise be the case, which in turn also makes them less valuable as a channel for individualized marketing messages targeted to the consumers who carry them.

Thus there is a need for another type of TSM services that enables banks, merchants, and other service providers to instantly provision their own credit, debit, prepaid, loyalty, reward, access, transit and other cards on mobile devices.

### SUMMARY OF THE INVENTION

This section is for the purpose of summarizing some aspects of the present invention and to briefly introduce some preferred embodiments. Simplifications or omissions may be made to avoid obscuring the purpose of the section. Such simplifications or omissions are not intended to limit the scope of the present invention.

The present invention is related to techniques for realizing or providing controllable trusted service management. According to one aspect of the present invention, one embodiment is related to empowering a service provider with application provisioning, applet and secures element (SE) management capabilities. A service management module, herein referred to as Controllable TSM or CTSM, is provided to a service provider to provision applications distributed through the service provider. A system or platform contemplated in this invention allows a service provider to operate under a supplementary security domain (SSD) installed by an SE issuer or an updated SSD key set exclusively known to the service provider. Such a platform is designed to support embedded SE (eSE) and can be extended to support UICC-based SE. With the CTSM, a service provider can use the SSD to personalize applets installed on each SE securely and independently.

According to another aspect of the present invention, the CTSM is configured to provide to a service provider a capability of replacing or updating SSD keysets, multi applications supports, applet life cycle management and SE life cycle management.

According to still another aspect of the present invention, for ease of integration and deployment, the CTSM has a plug-in based architecture for integration with an external system already deployed by a service provider. Thus a service provider can easily deploy a plug-in to integrate the CTSM into an existing process (e.g., data being prepared into the CTSM).

One important features, advantages and benefits in the present invention is to enable a service provider to control personalizations/provisions of some applications. Different from the trusted service manager that is to help a plurality of service providers distribute and manage contactless services for their customers and does not participate in actual transactions, a server implementing the CTSM is one of a plurality of servers that are operated and controlled by the service provider and involved in an actual transaction.

The present invention may be implemented as a single device, a server, a system or a part of system. It is believed that various implementations may lead to results that may not be achieved conventionally. According to one embodiment, the present invention is a system for managing a plurality of mobile devices, the system comprises: a first server configured to establish a secure channel with a mobile device using a supplementary security domain (SSD) when a request to provision an application installed in the mobile device, wherein the mobile device includes a secure element already personalized via a trusted service manager with the SSD, the application distributed by a service provider is preinstalled in or downloaded into the mobile device, the first server obtains respective identifiers of the secure element and the application from the mobile device and updates the SSD; and a hardware security module, coupled to the first server, configured to compute a new key set based on a key set of the SSD, wherein the first server is configured to interact with the hardware security module to retrieve the new key set so as to generate a new SSD for the secure element.

According to another embodiment, the present invention is a method for managing a plurality of mobile devices, the method comprises: receiving a request in a first server from a mobile device to provision an application installed in the mobile device, wherein the mobile device includes a secure element already personalized via a trusted service manager with a supplementary security domain (SSD), wherein the application distributed by a service provider is preinstalled in or downloaded into the mobile device; establishing a secure channel between the first server and the mobile device using the SSD in responding to the request, wherein the first server obtains respective identifiers of the secure element and the application from the mobile device and updates the SSD; retrieving a new set key from a hardware security module configured to generate the new set key from a key set of the SSD; and determining an updated SSD based on the new set key so as to update the secure element with the updated SSD.

Other objects, features, and advantages of the present invention will become apparent upon examining the following detailed description of an embodiment thereof, taken in conjunction with the attached drawings.

### BRIEF DESCRIPTION OF THE DRAWINGS

The invention will be readily understood by the following detailed description in conjunction with the accompanying drawings, wherein like reference numerals designate like structural elements, and in which:

FIG. 1A shows a simplified architecture of an NFC-enabled mobile device with a secure element (SE);

FIG. 1B shows a flowchart or process of personalizing an SE according to one embodiment of the present invention;

FIG. 1C shows relationships among an SE manufacturer, a TSM admin and the TSM system for both offline and online modes;

FIG. 1D illustrates data flows among a user for an NFC device (e.g., an NFC mobile phone), the NFC device itself, a TSM server, a corresponding SE manufacturer and an SE issuer;

FIG. 1E shows a data flowchart or process of personalizing data flow among three entities: a land-based SAM or a network e-purse server, an e-purse acting as a gatekeeper, and a single function tag, according to one embodiment;

FIG. 2A shows a system configuration in which a portion of a TSM is implemented in what is herein referred to as controllable TSM or CTSM while the TSM missing the portion is referred to as central TSM or CTSM;

FIG. 2B shows a flowchart or process of updating the SSD according to one embodiment of the present invention;

FIG. 2C shows a flowchart or process of personalizing an applet related to an application already installed in a mobile device according to one embodiment of the present invention; and

FIG. 2D shows a flowchart or process 250 of applet and SE management according to one embodiment of the present invention.

### DETAILED DESCRIPTION OF THE INVENTION

In the following description, numerous specific details are set forth to provide a thorough understanding of the present invention. The present invention may be practiced without these specific details. The description and representation herein are the means used by those experienced or skilled in the art to effectively convey the substance of their work to others skilled in the art. In other instances, well-known methods, procedures, components, and circuitry have not been described in detail since they are already well understood and to avoid unnecessarily obscuring aspects of the present invention.

Reference herein to “one embodiment” or “an embodiment” means that a particular feature, structure, or characteristic described in connection with the embodiment can be included in at least one implementation of the invention. The appearances of the phrase “in one embodiment” or “in the embodiment” in various places in the specification are not necessarily all referring to the same embodiment, nor are separate or alternative embodiments mutually exclusive of other embodiments. Further, the order of blocks in process, flowcharts or functional diagrams representing one or more embodiments do not inherently indicate any particular order nor imply limitations in the invention. As used in this specification and the appended claims, the singular forms “a,” “an,” and “the” include plural referents unless the context clearly dictates otherwise. It should also be noted that the term “or” is generally employed in its sense including “and/or” unless the context clearly dictates otherwise.

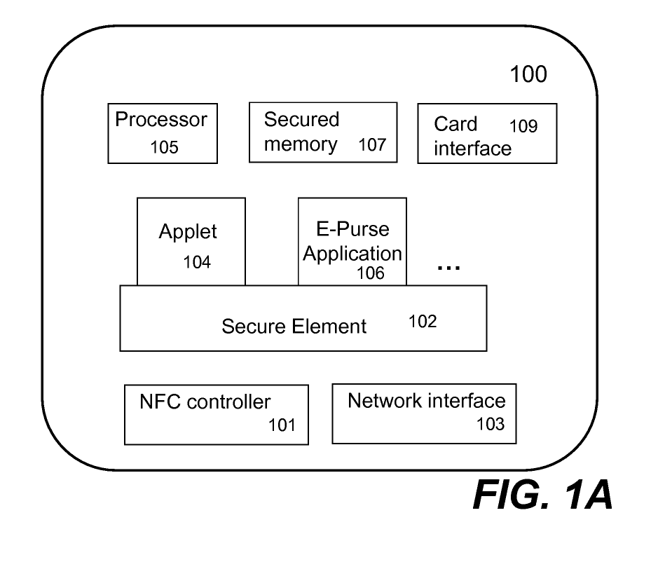

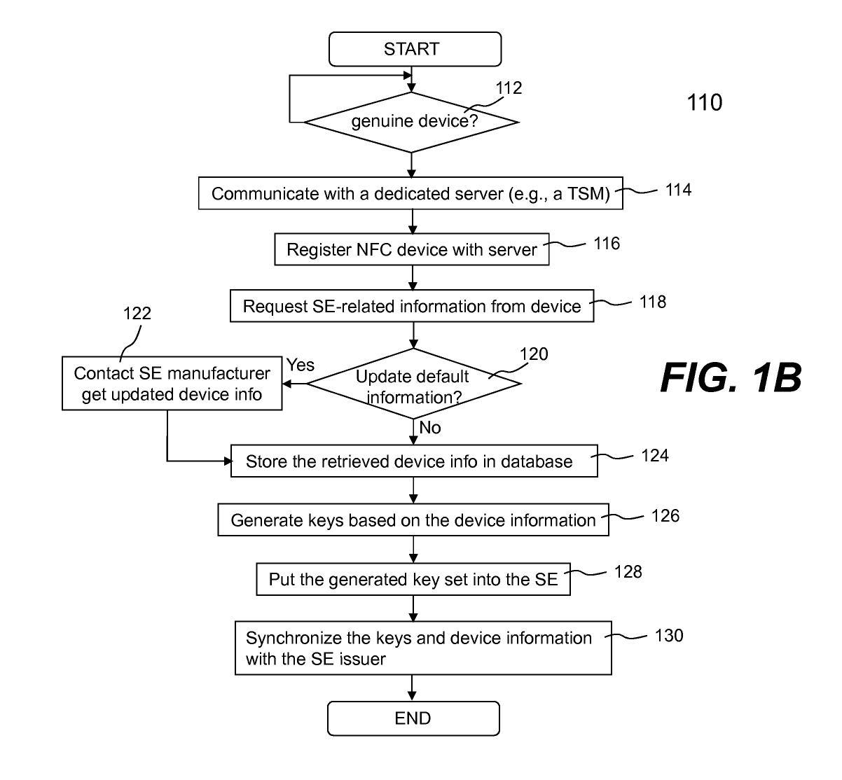

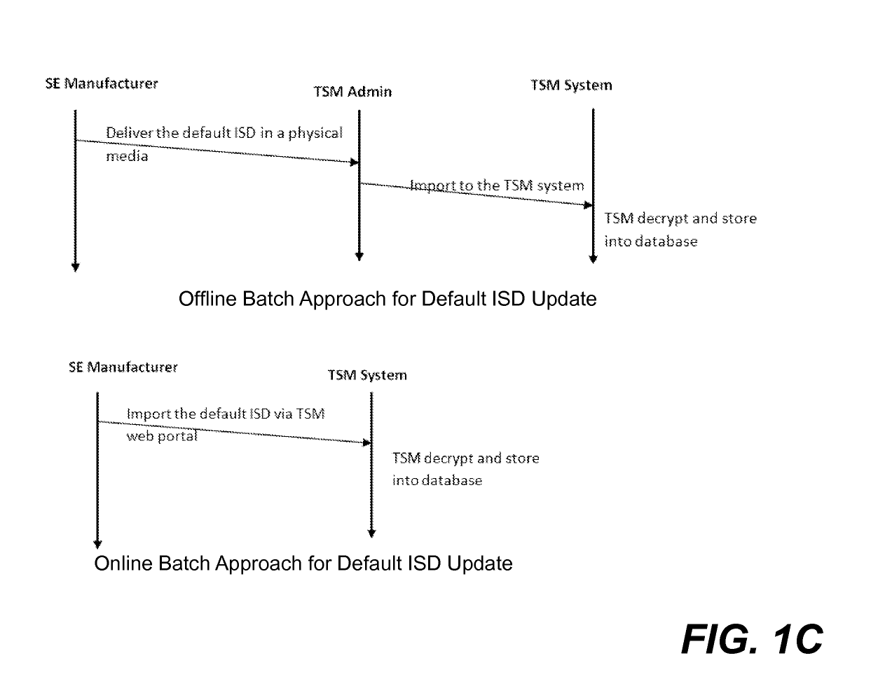

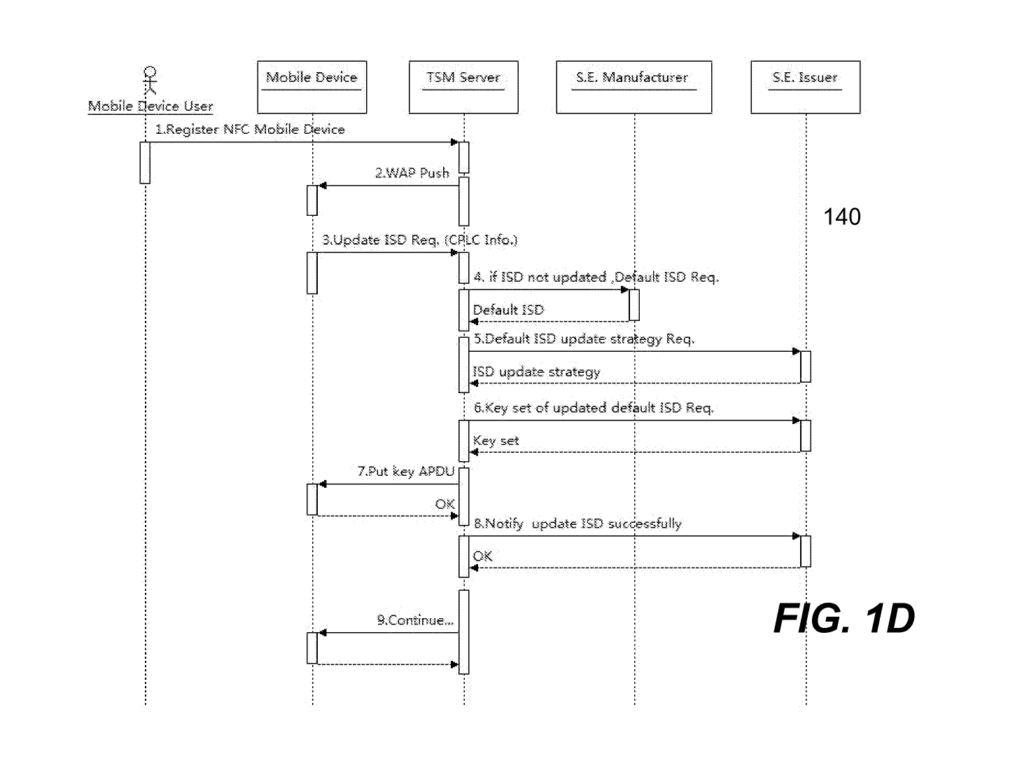

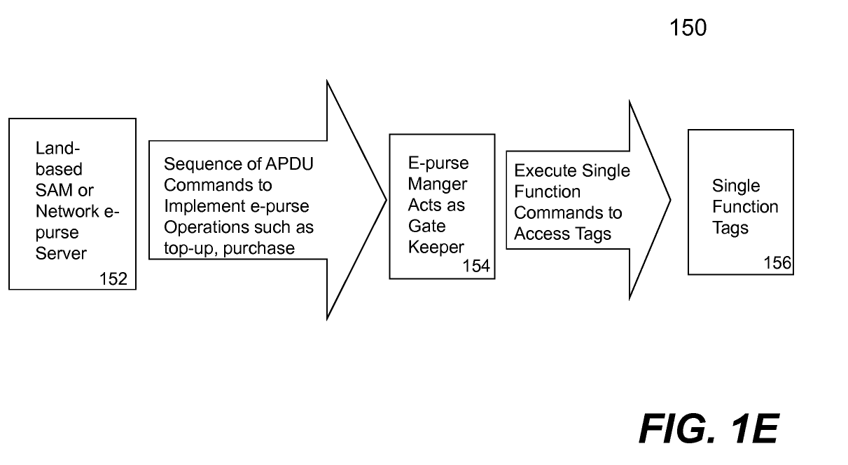

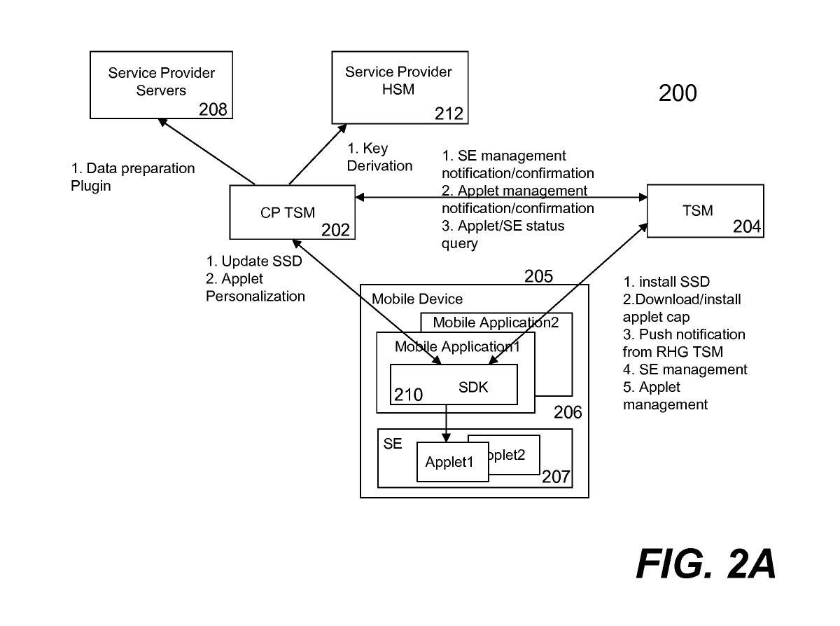

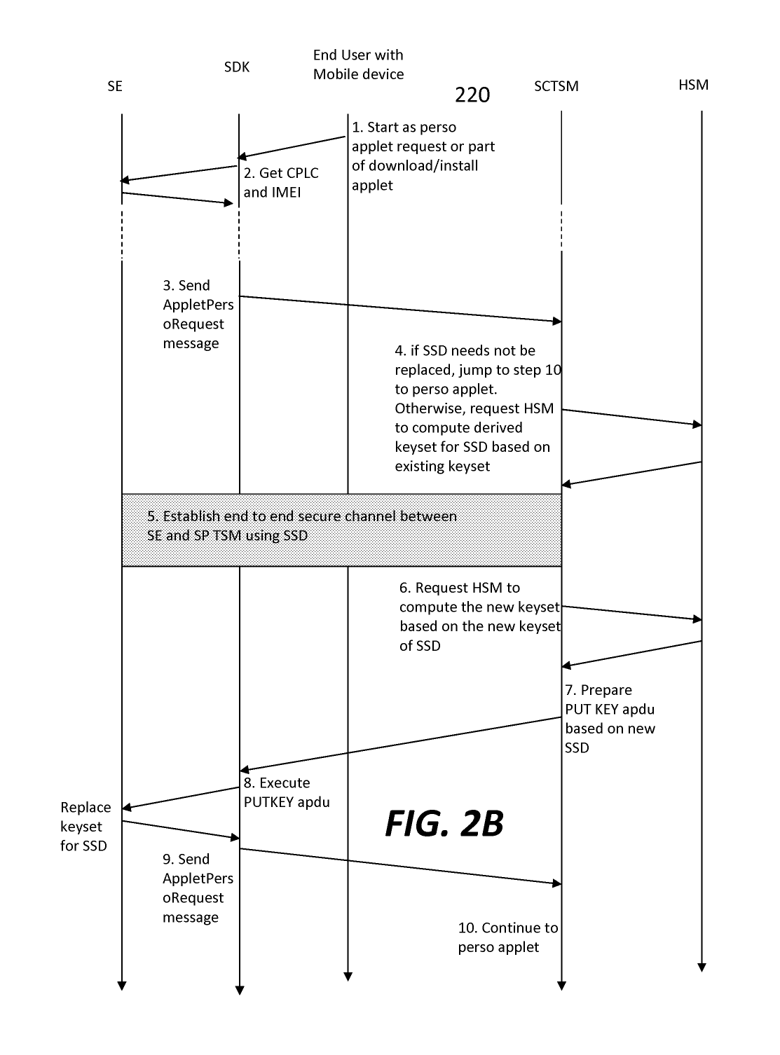

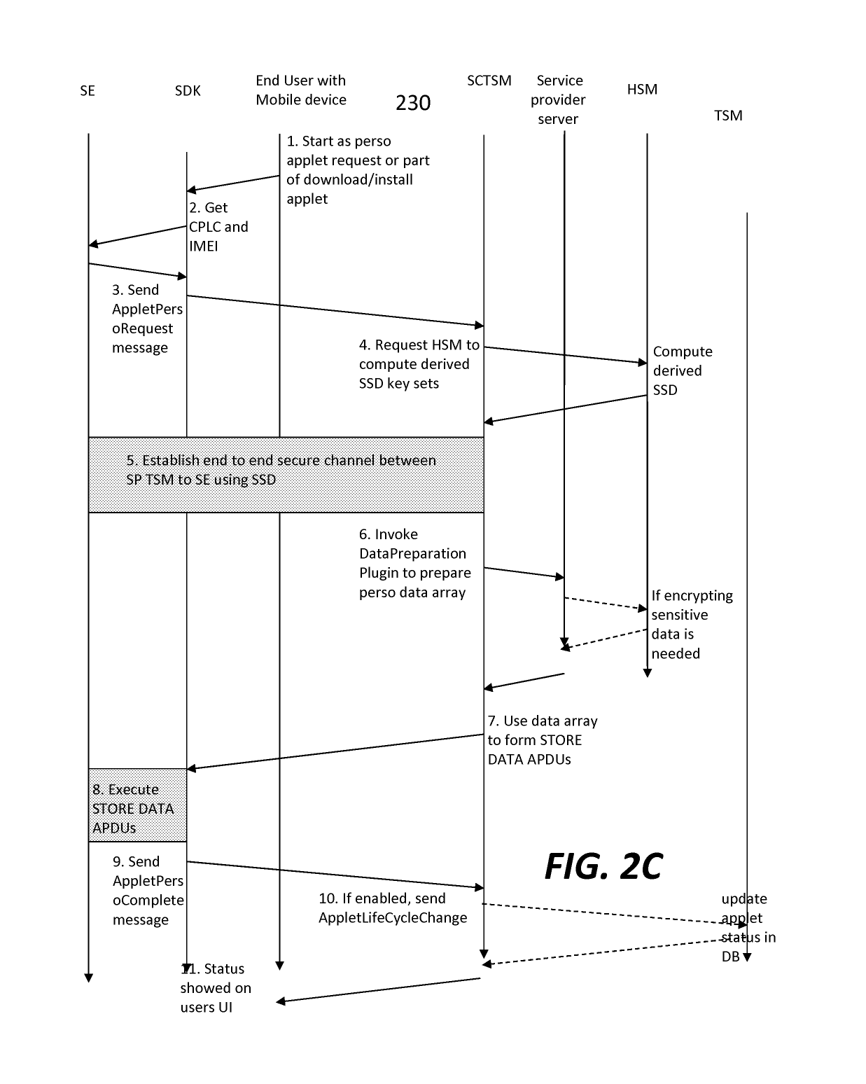

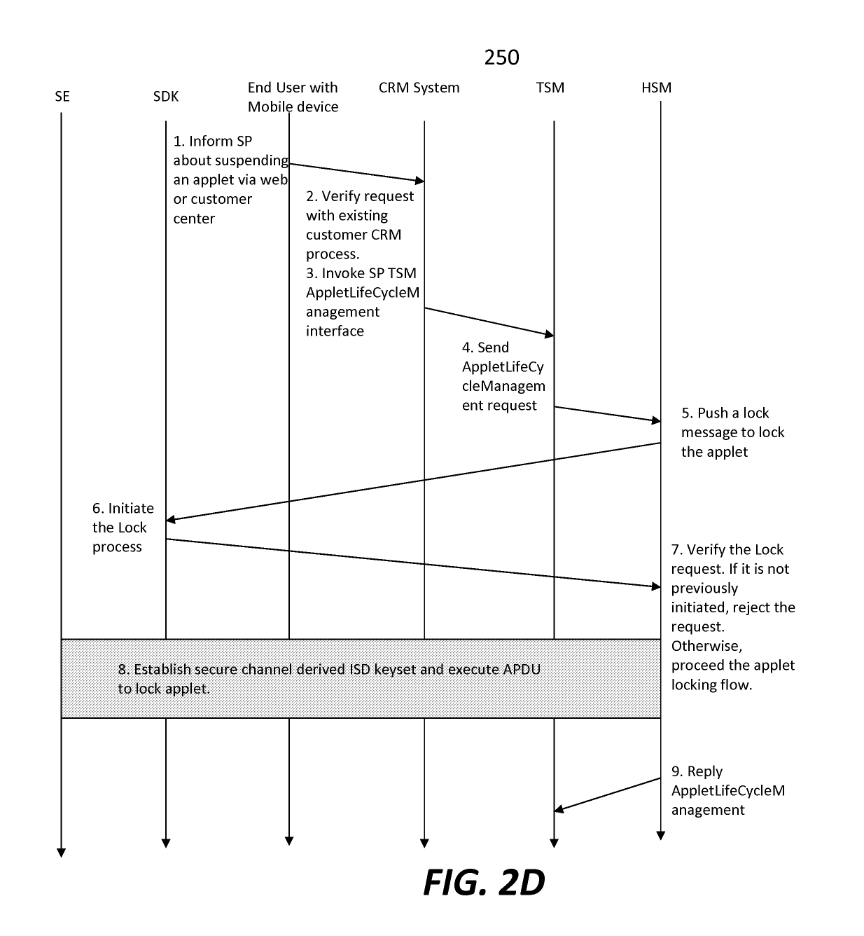

Embodiments of the present invention are discussed herein with reference to FIGS. 1A-2D. However, those skilled in the art will readily appreciate that the detailed description given herein with respect to these figures is for explanatory purposes only as the invention extends beyond these limited embodiments.

Near Field Communication (NFC) presents significant business opportunities when used in mobile phones for applications such as payment, transport ticketing, loyalty, physical access control, and other exciting new services. To support this fast evolving business environment, several entities including financial institutions, manufactures of various NFC-enabled mobile phones and software developers, in addition to Mobile Network Operators (MNO), become involved in the NFC mobile ecosystem. By nature of their individual roles, these players need to communicate with each other and exchange messages in a reliable and interoperable way.

Equally important to these entities or players, is the need for ongoing security and confidentiality of sensitive applications and data downloaded to and stored on an NFC enabled handset for performing contactless transactions. The component in a mobile phone providing the security and confidentiality required to support various business models in this environment, is referred to as a secure element (SE). In general, a secure element (SE) is a tamper-resistant platform (e.g., a single-chip secure microcontroller) capable of securely hosting applications and their confidential and cryptographic data (e.g., key management) in accordance with the rules and security requirements set forth by a set of well-identified trusted authorities. The common form factors of SE include: Universal Integrated Circuit Card (UICC), embedded SE and microSD. Both the UICC and microSD are removable. In one embodiment of the invention, a software module is configured to act as an SE and upgradable by overwriting some or all of the components therein. Regardless of the form factors, each form factor links to a different business implementation and satisfies a different market need.

FIG. 1A shows a simplified architecture of a computing device 100. Unless otherwise explicitly indicated, the term of “computing device”, “mobile device”, “portable device” or “handset” will be interchangeably used herein, but those skilled in the art will understand the description herein shall be equally applicable to other devices such as a smart phone, a tablet, a laptop computer, a contactless smart card and other portable device. The mobile device 100 includes a near field communication (NFC) controller 101 that enables the device 100 to interact with another device wirelessly to exchange data with. For example, a user may use the mobile device 100 as an e-purse or a wallet to pay for a purchase or an admission. In operation, the e-purse is controlled by a secure element (SE) 102. Essentially, the SE 102 enables such a mobile device 100 to perform a financial transaction, transport ticketing, loyalty, physical access control, and other exciting new services in a secured manner. To offer such services, the SE 102 is configured to support various applets, applications or modules (by way of example, only two exemplary applications 104 and 106 are shown in FIG. 1A). Depending on implementation, these modules may be hardware modules embedded or inserted thereon, or software modules downloadable from one or more servers via a data network.

When a mobile device is first purchased by or delivered to a customer, the SE 102 in the mobile device is installed with a set of default keys (e.g., an Issuer Security Domain (ISD) key set by the SE manufacturer). In one embodiment, the SE 102 is a tamper-proof chip capable to embed smart card-grade applications (e.g., payment, transport . . . ) with the required level of security and features. In FIG. 1A, the SE 102 is embedded or associated with various applications (e.g., NFC-related) and is connected to the NFC controller 101 to act as the contactless front end. Typically, a standard-compliant SE comes with one issuer security domain (ISD) and an option for one or more supplemental security domains (SSD). Each of these domains includes a set of keys. In one embodiment, the SE 102 is a chip embedded in the mobile device 100 or in a miniature card inserted into the mobile device 100 via a card interface 109. In another embodiment, the SE 102 is or includes a software module loaded in a secured memory space 107 in the mobile device 100. The software module may be updated by downloading updating components from a designated server using a network interface 103 (e.g., a 3G network or an LTE network) in the mobile device 100.

The SE 102 needs to go through a personalization process before it can be used. In one embodiment, the personalization process is to load the SE 102 with or update a key set with a derived personalized key set of a chosen card issuer (i.e., a so-called SE issuer). Depending on situation, an SE issuer and an SE manufacturer may be two separate entities or a single entity. To facilitate the description of the present invention, the SE issuer and the SE manufacturer will be described herein as if they are two separate entities. Further, a personalization process may be also referred to as a provisioning process. According to one embodiment, the SE provisioning process is performed over the air (OTA) to cause the SE to be personalized while installing an application or enabling a service (i.e., application installation and personalization). The personalization of an SE is only done once the SE is associated with an SE issuer. The application installation and provisioning shall be done for each application when a user subscribes or installs an application.

In one embodiment, when updating or upgrading the SE 102, only one or some components pertaining to the SE 102 are replaced by newer updates to avoid personalizing the SE 102 from beginning. Depending on implementation, such newer updates may be automatically or manually obtained to be loaded into the mobile device 100. In one embodiment, applications are available for an NFC-enabled mobile device for downloading from a server or a TSM portal depending on the corresponding SE issuer and the TSM thereof.

TSM, standing also for Trusted Service Management, is a collection of services. One main role envisaged for the TSM is to help service providers securely distribute and manage contactless services for their customers using the networks of mobile operators. The TSM or its server(s) does not necessarily participate in actual contactless transactions involving the NFC devices. These transactions are processed normally in whatever system the service provider and its merchant partners have already put in place. Another role of the TSM is to accelerate the successful deployment and ramp-up of mobile NFC applications by acting as a commercial intermediary that facilitates contractual arrangements and other aspects of ongoing business relationships among different parties that make the commerce via the mobile networks possible.

The personalization process can be done either physically in a service center or remotely via a web portal by a TSM server. In the first scenario, the customer may physically go to a service center to let a service representative to personalize the SE in a mobile device. With a computer connected to an NFC reader at a designated place (e.g., a service center), a provisioning manager can be either an installed application or a web-based application connecting to a backend TSM. The provisioning manager is configured to communicate with the SE of the mobile device (e.g., via a reader). Such a personalization process is referred to as a process Over the Internet (OTI).

In the second scenario, the customer registers his/her mobile phone via a server (often a TSM web portal). The TSM server is configured to push a universal resource identifier (URI) of a provisioning manager to the registered mobile phone. Depending on a type of the device, the push can be either an SMS (Short Message Service) Push or a Google Android Push. The customer can download the provisioning manager into the mobile device and start the personalization process. Such a personalization process is referred to as a process Over the Air (OTA).

In either one of the scenarios, the provisioning manager acts as a proxy between the SE in the mobile device and the TSM server. Referring now to FIG. 1B, it shows a flowchart or process 110 of personalizing an SE according to one embodiment of the present invention. Depending on implementation, the process 110 may be implemented in software or a combination of software and hardware. When a user receives a new NFC device (e.g., a part of a mobile device), the SE therein needs to be personalized.

At 112, the new NFC device is determined if it is a genuine NFC device. One example is to check a serial number associated with the NFC device. The serial number may be verified with a database associated with a TSM server. In the example of an NFC mobile device, the device serial number of the mobile device may be used for verification. It is now assumed that the NFC device is a genuine device (recognizable by a mobile operator). The process 110 goes to 114 to have the NFC device communicated with a dedicated server. In one embodiment, the server is a part of the Trusted Service Management (TSM) system and accessible via a wireless network, the Internet or a combination of wireless and wired networks (herein referred to as a data network or simply a network).

At 116, the NFC device is registered with the server. Once the NFC device becomes part of the system, various services or data may be communicated to the device via the network. As part of the personalization process, the server requests device information of the SE at 118. In one embodiment, the server is configured to send a data request (e.g., a WAP PUSH) to the device. In responding to the request, the device sends back CPLC (card product life cycle) information retrieved from the SE. The CPLC includes the SE product information (e.g., the smart card ID, manufacturer information and a batch number and etc.). Based on the CPLC info, the server is able to retrieve corresponding default Issuer Security Domain (ISD) information of this SE from its manufacturer, its issuer, an authorized distributor or a service provider. Depending on implementation, there are two ways that the server may communicate with an SE distributor or manufacturer, which will be fully discussed herein late when deemed appropriate.

At 120, it is up to the manufacturer whether to update the device information. In general, when an SE is shipped from the manufacturer, the SE is embedded with some default device information. If it is decided that the default information such as the CPLC data is to be updated with the manufacturer, the process 110 goes to 122, where the manufacturer uploads corresponding updated device information to the server. The updated device information is transported to the device and stored in the SE at 124. If it is decided that the default information in the SE is not to be updated with the manufacturer, the process 110 goes to 124 to store the retrieved default device information in a database with the TSM server. In one embodiment, the server is configured to include an interface to retrieve a derived SE key set from the mobile device. According to one embodiment, the derived key set is generated with the device information (e.g., ISD) of the SE. When the derived ISD key set is successfully installed on the SE, the corresponding SE issuer is notified of the use of the derived ISD key set.

According to one embodiment, the device information (default or updated) is used to facilitate the generation of a set of keys at 126. In operation, the server is configured to establish a secured channel using the default ISD between its hardware security module (HSM) and the SE. The server is also configured to compute a derived key set for the SE. Depending on a business agreement, a master ISD key of an issuer for the SE may be housed in a hardware security module (HSM) associated with the server or in a local HSM of the SE issuer. An HSM is a type of secure crypto-processor provided for managing digital keys, accelerating crypto-processes in terms of digital signings/second and for providing strong authentication to access critical keys for server applications. If it is housed in the HSM of the server, the server is configured to instruct the HSM to compute the derived key set. Then, the server prepares a mechanism (e.g., PUT KEY APDU) and uses the default channel to replace the default key set originally in the SE with the derived key set. If the master ISD key of the SE issuer is in a local HSM of the SE issuer, the server is configured to interact with the remote HSM to retrieve the keys.

At 128, the set of keys is securely delivered to the SE. The set of keys is thus personalized to the SE and will be used for various secured subsequent operations or services with the NFC device. The server at 130 is configured to synchronize the SE with the issuer or provider (e.g., sending a notification thereto about the status of the SE). After the personalization, the SE can only be accessed using the personalized ISD key of the SE issuer. Depending on the security requirement of each service provider, the TSM can create additional SSDs for the various providers to personalize their respective applications (e.g., the modules 104 or 106 of FIG. 1A).

As mentioned above, there are two ways that may be used to retrieve the corresponding default Issuer Security Domain (ISD) information from the SE in interfacing with the manufacturer thereof. Depending on the infrastructure, a manufacturer can choose to use a real-time approach or a batch approach.

In the real-time approach, the server is configured to communicate with the manufacturer (i.e., its server thereof) when an SE by the manufacturer is being personalized by the TSM server. The default key set is, thus, retrieved on demand from the server of the manufacturer. In one embodiment, the TSM server includes a plugin module for each of the manufacturers to communicate therewith.

In the batch approach, it can be done either offline mode or online mode. In the offline mode, the SE manufacturer delivers the default ISD information for all SEs being supported via an encrypted physical media. An administrator for the TSM may or a computing device may be configured to import the information in a media to a computing device. The default ISDs are then decrypted and retrieved, and stored in a database. In the online mode, the SE manufacturer uploads the default ISD information for the SEs it supports via a network. The default ISDs are then decrypted and retrieved, and stored in a database. Afterwards, the TSM only needs to access its own HSM o the database during an SE personalization process.

In one perspective, the SE 102 of FIG. 1A may be perceived as a preload operating system in a smart card, providing a platform for PIN management and security channels (security domains) for card personalization. The SE 102 combines the interests of smart card issuers, vendors, industry groups, public entities and technology companies to define requirements and technology standards for multiple applications running in the smart cards. As an example, one module 104 referred to as an e-purse security defines a set of protocols that enable micro payment transactions to be carried out over a data network. With an electronic purse (a.k.a., e-purse application) stored on a smart card, a set of keys (either symmetric or asymmetric) is personalized into the e-purse after the e-purse is issued. During a transaction, the e-purse uses a set of respective keys for encryption and MAC computation in order to secure the message channel between the e-purse and an SAM (Security Authentication Module) or backend servers. For a single functional card, the e-purse security 104 is configured to act as gates to protect actual operations performed on a single functional card. During personalization, the single functional card access keys (or its transformation) are personalized into the e-purse with the e-purse transaction keys. FIG. 1C shows respective relationships among the SE manufacturer, the TSM admin and the TSM system for both offline and online modes. FIG. 1D illustrates data flows among a user for an NFC device (e.g., an NFC mobile phone), the NFC device itself, a TSM server, a corresponding SE manufacturer and an SE issuer according to one embodiment.

In one perspective, the SE 102 of FIG. 1A may be perceived as a preload operating system in a smart card, providing a platform for PIN management and security channels (security domains) for card personalization. The SE 102 combines the interests of smart card issuers, vendors, industry groups, public entities and technology companies to define requirements and technology standards for multiple applications running in the smart cards. As an example, one module 104 referred to as an e-purse security defines a set of protocols that enable micro payment transactions to be carried out over a data network. With an electronic purse (a.k.a., e-purse application) stored on a smart card, a set of keys (either symmetric or asymmetric) is personalized into the e-purse after the e-purse is issued. During a transaction, the e-purse uses a set of respective keys for encryption and MAC computation in order to secure the message channel between the e-purse and an SAM (Security Authentication Module) or backend servers. For a single functional card, the e-purse security 104 is configured to act as gates to protect actual operations performed on a single functional card. During personalization, the single functional card access keys (or its transformation) are personalized into the e-purse with the e-purse transaction keys.

As an example, it is assumed that an installed application, e-purse, has been provisioned with the SE. FIG. 1E shows a flowchart or process 150 of data flow among three entities: a land-based SAM or a network e-purse server 152, an e-purse 154 acting as a gatekeeper, and a single function tag 156. Communications between the land-based SAM or the network e-purse server 152 and the e-purse 154 are conducted in sequence of a type of commands (e.g., APDU) while communications between the e-purse 154 and the single function tag 156 are conducted in sequence of another type of commands, wherein the e-purse 154 acts as the gate keeper to ensure only secured and authorized data transactions could happen.

In one embodiment, the physical security for the e-purse is realized in an emulator. As used herein, an emulator means a hardware device or a software module that pretends to be another particular device or program that other components expect to interact with. The e-purse security is realized between one or more applets configured to provide e-purse functioning and communicate with a payment server. An SE supporting the e-purse is responsible for updating security keys to establish appropriate channels for interactions between a payment server and the applets, wherein the e-purse applet(s) acts as a gatekeeper to regulate or control the data exchange.

As described above, it can be appreciated that an independent TSM is the key to the provisioning of applications to NFC-enabled phones such that they have the broadest possible purchasing power for the consumer. However, it is difficult to keep the TSM so neutral to all parties involved. FIG. 2A shows a system configuration 200 in which a portion of the TSM is functioning is implemented in what is herein referred to as controllable TSM or CTSM 202 while the TSM missing the portion is still referred to as TSM 204. It should be noted that the implementation and architecture of TSM 204 and TSM 204 shall not be simply perceived as a trivial separation of the TSM described above. The CTSM 202 is configured to provide a rich but not overwhelming subset of the TSM functionalities to service providers to provision applets and manage a life cycle of applets and SEs. As will be further described below, the operations of FIG. 2A are substantially different from that using a single TSM.

As the name suggests, a CTSM is controlled or operated by a service provider to provision applets and manage a life cycle of the applets and SEs distributed or supported by the service provider while CTSM still perform many functions that a TSM is supposed to perform. Unless explicitly stated, CTSM and TSM will be used hereafter interchangeably. Under one CTSM, there may be a number of CTSMs collaborating with the CTSM. As a result, the CTSM is neutral to all business entities in the mobile ecosystem.

According to one embodiment, the CTSM 202 in FIG. 2A is configured to perform at least the following functions in conjunction with a TSM 204. The CTSM 202 is controlled or operated by a service provider. According to one embodiment, the CTSM 202 is implemented in a server operated by the service provider. For illustration purpose, the CTSM 202 is shown separately from other servers by the service provider. As an example, shown in FIG. 2A, the CTSM 202 is coupled between a mobile device 206 and at least one server 208 by the service provider, where the mobile device 206 communicates with the CTSM 202 over a wired and/or wireless network. The following functions are some of those specifically performed by the CTSM 202.

1. Replace Supplemental Security Domains (SSD)

Many of the CTSM 102 functionalities are made possible with supplementary security domains (SSDs). In order to enable a service provider to independently provision certain applications on designated SEs, the SE issuer or a TSM will have to install at least one SSD for these SEs. After an SSD is installed, the service provider can manage the SE using the CTSM 102 with the installed SSD therein. Operationally, the service provider relies on the CTSM 102 to establish an end-to-end secure channel between the CTSM 102 and a card manger on the SEs. To further eliminate the security concerns, the CTSM 102 is configured to enable the service provider to replace an existing SSD keyset with a new set of values that is only known to the service provider, where the initial keyset is at least known between the respective service provider and the SE issuer. After the CTSM 102 moves to replace the keyset, the new keyset is solely known to the service provider.

2. Applet Personalization

The applets provided by a service provider can be pre-installed on an SE during manufacturing process. They can also be downloaded and installed on the SE by an end user via the CTSM 202 or TSM 204. With the SSD installed on the SE 207 in FIG. 2A, the SC TSM 202 can use the SSD to establish a first establish secure channel and then use the channel to personalize an installed applet when an end user requests to personalize it. In one embodiment, for each applet, the service provider needs to implement a data preparation plug-in to integrate the CTSM 202 into its existing infrastructure for preparing the personalized data for the requested SE. The personalized data is composed as a sequence of STORE DATA commands by the SC TSM 202 and sent via the SSD-based secure channel to the applet residing on the SE.

3. Support Multiple Applets

As described above, the CTSM 202 can be configured to a service provider to publish many applications. For each application, the service provider can maintain multiple versions in the platform. For each application, the service provider can know which application the SE has been associated with and the associated mobile device (e.g., SE UID and IMEI) that has activated the application. Various statistics, including customized statistic models, can also be obtained from the platform formed by a plurality of mobile devices. According to one embodiment, the CTSM 202 is GP compliant. The platform supports both embedded SE (eSE) and UICC based SE.

4. Applet and SE Management

The CTSM 202 has the capability to work with the TSM 204 to perform both applet and SE life cycle management. The Applet life cycle management includes applet deletion and applet locking. The SE life cycle management includes SE locking, and SE termination. The CTSM 202 provides interfaces for be integrated into an existing backend system of a service provider. Once the service provider verifies the request, it can invoke the CTSM 202 to notify the TSM 202 to perform various management functions.

5. Plugin Architecture

The CTSM 202 has a plug-in architecture that enables easy integration with an existing infrastructure of the service provider. To integrate the CTSM 202 with an existing data preparation, the service provider needs to implement the data preparation plug-in interface in one embodiment. The CTSM 202 is configured to go through the plug-in to collect data prepared for personalization.

System Interaction

The CTSM 202 may be provided separately by a third party (e.g., a software company) but controlled or operated by a service provider. FIG. 2A further shows how the CTSM 202 interacts with the TSM 204, servers (collectively a server) 208 being operated by the service and the mobile applications already installed in the mobile device 205. The mobile applications interact with both the CTSM 202 and the TSM 204 via one or more components or interfaces 210 (e.g., provided in an SDK) 210. For example, when the platform is based on Android, the interfaces or SDK 210 is running in the background and interacts with the CTSM 202 or the TSM 204.

According to embodiment, the interactions between the CTSM 202 and TSM 204 or the SDK 210 include:
Update SSD: After the TSM 204 installs the SSD in the mobile device 205 via the SDK 210, the CTSM 202 can request the SDK 210 to start a replacing SSD operation.
Applet Personalization: the TSM 204 is responsible for downloading and installing an applet on an SE. The CTSM 202 is then activated to personalize the applet.
   the interactions between the CTSM 202 and the TSM 204 include:
The CTSM 202 notifies the TSM 204 about an applet life cycle event change on an SE (for example, the TSM 204 pushes a message to the mobile device 205)
The CTSM 202 is being notified by the TSM 204 about the SE life cycle event change.
Either one of the CTSM 202 and the TSM 204 is configured to provide queries about the SE life cycle state and the applet life cycle state on a SE.
   the interactions between the CTSM 202 and Service Provider HSM include:
The service provider develops an HSM plug-in using an HSM interface in the SC TSM 202 to integrate with its HSM 212 for derived SSD keyset computation, and data encryption of sensitive personalized data.

the interactions between the CTSM 202 and Service servers 208 include:
The service provider develops data preparation plug-in for preparing data arrays for applet personalization.

The details for the plug-in and interfaces will be further discussed below.

Updating SSD is one part of the personalization process. If the CTSM 202 detects that the SSD must be updated or replaced, it starts to update the SSD. FIG. 2B shows a flowchart or process 220 of updating the SSD. The process 220 may be implemented in software or a combination of software and hardware. In principle, a security channel must be established between the CTSM and an SE to be personalized using the keyset derived from the initial SSD master keyset. Then, the CTSM 202 is configured to compute a new derived keyset for the SE using the new master SSD key set. In one embodiment, the new keyset value includes PUT KEY APDU and is sent to the SE for replacement. The service provider uses to the HSM plug-in to integrate the HSM to the CTSM.

Respectively labeled in FIG. 2B, various actions are taken by respective entities. FIG. 2B may be further understood in conjunction with FIG. 2A.
1. In one embodiment, a mobile device has installed an application that may be preinstalled or downloaded from a network. The personalization of the application may be activated by a user selecting the application to subscribe or a provider thereof pushes a notification to the mobile device.
2. The interface or SDK 210 of FIG. 2A is configured to retrieve from the SE in the mobile device its CPLC information, and send CPLC and requested application info to the CTSM (e.g., the CTSM 202).
3. The interface or SDK 210 then sends a request message (e.g., AppletPersoRequest) to the CTSM. The request includes IMEI and CPLC of the mobile device and an application ID.
4. If the SSD needs not be replaced, the process 220 goes to 10 to continue the applet personalization. Otherwise, the CTSM requests the HSM of the service provider to compute the derived SSD for the SE.
5. The CTSM goes ahead to establish a secure channel with the SE using this derived SSD. This should include two rounds messaging exchanged between the CTSM 202 and the interface or SDK 210 to achieve mutual authentication (e.g., use INITIAL UPDATE and EXTERNAL AUTHNTICATION).
6. The CTSM 202 requests the HSM of the service provider to compute the derived SSD for the new keyset for this SE.
7. The CTSM 202 composes a command (e.g., PUTKEY) and wraps it in a response message back to the SDK 210.
8. Upon receiving the response message, the SDK 210 extracts the PUTKEY APDU and executes against the SE. The SE will replace the SSD with the new derived keyset.
9. The SDK 210 then sends the applet personalization message (e.g., AppletPersoRequest) again to the CTSM 202. As the keyset of SSD has already been replaced, the process 220 goes to 10.
10. The CTSM 202 now continues the applet personalization.

FIG. 2C shows a flowchart or process 230 of personalizing an applet. As part of the applet personalization, the CTSM 202 has established a secure channel using the latest SSD keyset. If the keyset has been replaced, the new keyset must be used. This ensures that that personalized data is wrapped or secured with the new SSD keyset that is solely known to the service provider. Various actions are taken by respective entities. FIG. 2C may be further understood in conjunction with FIG. 2A.
1. In one embodiment, a mobile device has installed an application that may be preinstalled or downloaded from a network. The personalization of the application may be activated by a user selecting the application to subscribe or a provider thereof pushes a notification to the mobile device.
2. The interface or SDK 210 of FIG. 2A is configured to retrieve from the SE in the mobile device its CPLC information, and send CPLC and requested application info to the CTSM (e.g., the CTSM 202).
3. The interface or SDK 210 then sends a request message (e.g., AppletPersoRequest) to the CTSM. The request includes IMEI and CPLC of the mobile device and an application ID.
4. If the applet request has not been done, this process 230 will be aborted and a notification will be sent to the user. Otherwise, the CTSM requests the HSM of the service provider to compute the derived SSD for the SE.
5. The CTSM goes ahead to establish a secure channel with the SE using this derived SSD. This should include two rounds messaging exchanged between the CTSM 202 and the interface or SDK 210 to achieve mutual authentication (e.g., use INITIAL UPDATE and EXTERNAL AUTHNTICATION).
6. The CTSM 202 invokes the data preparation plugin to use a designated server to prepare the personalized data for the SE. The designated or personalization server may need to further connect to the HSM if encrypting sensitive data is needed.
7. The personalized data is then used to compose a data set (e.g., a sequence of STORE DATA APDUs). The final data preparation script is wrapped in a response message and returned to the SDK 210.
8. After extracting the STORE DATA APDUs from the response message, the SDK 210 executes STORE DATA against the SE sequentially to personalize the applet.
9. The SDK 210 sends a response message (e.g., applet perso complete message) to the CTSM 202. The message will include the status of all STORE DATA APDUs, SE UID, IMEI, Application ID, and transaction ID.
10. If enabled by the service provider, the CTSM 202 uses a notification (e.g., the AppletLifeCycleChange notification) to inform the RHG about the status of the applet provision. This notification includes SE UID, IMEI, Application ID, and respective statuss.
11. The result is then shown on the mobile device.

FIG. 2D shows a flowchart or process 250 of applet and SE management. Besides supporting a provisioning process, one embodiment of the present invention also supports the life cycle management of an SE and an install application. The life cycle management includes, but may not be limited to, SE lock, SE unlock, application Delete (disabling). The initiation of these activities may be through a push notification from a CTSM controlled and operated by a service provider. In actual use of mobile devices, For some reason (e.g., no activity for a prolonged period or expiration), an application needs to be disabled or locked by its distributor or provider.

According to on embodiment, the CTSM 202 is configured to provide both applet and SE life cycle management functionalities to a service provider. Respectively labeled in FIG. 2D, various actions are taken by respective entities. FIG. 2D may be further understood in conjunction with FIG. 2A.
1. Service provider detected to see if there is a request and verify the request when there is one.
2. A designated server by the service provider invokes the CTSM 202 to obtain the request (e.g., via an AppletLifeCycleManagement interface) that typically includes parameters of SE UID, IMEI, applet ID, and action.
3. Upon receiving the request, the CTSM is configured to send a request (e.g., AppletLifeCycleManagement to the TSM 204.
4. The TSM 210 registers the request and pushes a notification message to request the SDK 210 to initiate a lock applet process.
5. Upon receiving the notification, the SDK 210 sends a message to request the TSM 204 to lock the applet.
6. The TSM 204 is then to verify the request against a notification registration repository. If the request is not initiated from the TSM 204, the request will be rejected. Otherwise, the TSM 204 continues the locking process.
7. The TSM 204 first establishes a secure channel between itself and the SE. It then composes a message (e.g., APDUs) for the SDK 210 to execute against the SE to lock the applet therein.
8. The TSM 204 sends a response (e.g., AppletLifeCycleManagement) to inform the CTSM 202 about the status. Conversely, the CTSM 202 can use the interface (e.g., AppletInfo) to request the TSM 204 about the status of an applet on the SE.

According to one embodiment, a CTSM includes a Java SDK which provides two mechanisms to integrate itself with an existing external system by a service provider. The first mechanism is one or more interfaces and the second is one or more plug-ins. The former is for the external system to make use of services provided by the CTSM to integrate some features of the CTSM into the existing external system. The latter is for the CTSM to make use of the existing services provided by external systems to integrate some features of the external systems into the CTSM.

In one embodiment, the CTSM makes available the applet life cycle management and the SE management via set of web service interfaces for the external system. The plug-ins of the various workflows are provided by the CTSM for the service provider to integrate the existing external services to the respective workflows provided the CTSM. A service provider needs only to implement small java programs to realize the plug-in interfaces.

Exemplary interfaces include the following interfaces.

### AppletLifeCycleChange Request

This interface allows a service provider to integrate the CTSM into its existing customer relationship management (CRM) flow. The CRM software needs only to invoke this API to request the CTSM to perform the applet life cycle change action once it is done with the existing procedures for an SE.

### AppletLifeCycleChange Notification

This is a callback for the TSM to inform the CTSM any change in the life cycle state of its application on an SE. This can be used for the TSM to install new applet on the SE.

### SELifeCycleChange Notification

This is a callback mechanism for the TSM to inform the CTSM any change in the life cycle of the SE that has installed with one of its applets.

There are two major plug-in interfaces for the CTSM. The data preparation interface and the HSM interface.

### Data Preparation

There are two Java interfaces for the data preparation plugin. One is for Mifare applications and the other is for JavaCard applets.
To prepare data for Mifare applications, this Data Preparation interface may be implemented as follows.

```
public interface MifareDataPreparation {
  /** This is the data preparation plug-in interface for a Mifare application
  * @param personalD Personal ID in HEX
  * @param cardInfo ,card information
  *
  * @return a Mifare application including both data blocks and Key
  blocks
  */
  public MifareApp prepareMifareApp(String personalD, CardInformation
  cardInfo);
}
```

To prepare data for JavaCard applets, this interface may be implemented as follows.

```
public interface DataPreparation {
  /**
  * This is the data preparation plugin interface for a JavaCard Applet;
  * @param personalD Personal ID in HEX
  * @param cardInfo ,card information
  * @param securityChannel, this is for encrypting sensitive data
  * @return 0 or more STORE DATA apdu
  */
  public byte [ ] [ ] prepareStoreData(String personalD, CardInformation
cardInfo, SecurityChannel securityChannel);
  }
```

According to one embodiment, the provider of physical HSM needs to develop a plug-in to implement the RFCHSM interface. This interface is used by high level applications to request cryptographic services from the respective HSM.

```
public interface RFCHSM {
  public int encryptDES_ECB_NoPadding(HSMKey hsmKey, byte[ ] input,
      int inputOffset, int inputLen, byte[ ] output, int outputOffset)
      throws Exception ;
  public int decryptDES_ECB_NoPadding(HSMKey hsmKey, byte[ ] input,
      int inputOffset, int inputLen, byte[ ] output, int outputOffset)
      throws Exception ;
  public int encryptDES_CBC_NoPadding(HSMKey hsmKey, byte[ ] icv,byte[ ]
input,
      int inputOffset, int inputLen, byte[ ] output, int outputOffset)
      throws Exception ;
  public int decryptDES_CBC_NoPadding(HSMKey hsmKey, byte[ ] icv,byte[ ] input,
      int inputOffset, int inputLen, byte[ ] output, int outputOffset)
      throws Exception ;
  public int encryptDESede_ECB_NoPadding(HSMKey hsmKey,
      byte[ ] input, int inputOffset, int inputLen, byte[ ] output,
      int outputOffset) throws Exception ;
  public int decryptDESede_ECB_NoPadding(HSMKey hsmKey,
      byte[ ] input, int inputOffset, int inputLen, byte[ ] output,
      int outputOffset) throws Exception;
  public int encryptDESede_CBC_NoPadding(HSMKey hsmKey, byte[ ] icv,
      byte[ ] input, int inputOffset, int inputLen, byte[ ] output,
      int outputOffset) throws Exception ;
  public int decryptDESede_CBC_NoPadding(HSMKey hsmKey, byte[ ] icv,
      byte[ ] input, int inputOffset, int inputLen, byte[ ] output,
      int outputOffset) throws Exception ;
  public int generateRandom(int length, byte[ ] output, int outputOffset)
  throws Exception ;
  public boolean init( ) throws Exception ;
  public boolean release( ) throws Exception;
}
```

The CTSM provides a flexible and easy way for a service provider to deploy the system. The service provider will use the SDK to do some simple programming to integrate the CTSM with its existing systems, and use a user friendly web UI to publish applications to all users subscribing to the service provider.

To publish an application to the system, the service provider performs the following steps.
1. Implement a data preparation plug-in as described above for an applet of the application
2. Integrate the applet management to its current CRM flow, if it has not done so (note this integration should only be done once for all applications)
3. Use the web UI to add SSD, if it has not previously done so. This is also done once for all applications.
4. Use web UI to add an application and submit its applet that needs to be personalized.

The invention is preferably implemented by software, but can also be implemented in hardware or a combination of hardware and software. The invention can also be embodied as computer readable code on a computer readable medium. The computer readable medium is any data storage device that can store data which can thereafter be read by a computer system. Examples of the computer readable medium include read-only memory, random-access memory, CD-ROMs, DVDs, magnetic tape, optical data storage devices, and carrier waves. The computer readable medium can also be distributed over network-coupled computer systems so that the computer readable code is stored and executed in a distributed fashion.

The present invention has been described in sufficient details with a certain degree of particularity. It is understood to those skilled in the art that the present disclosure of embodiments has been made by way of examples only and that numerous changes in the arrangement and combination of parts may be resorted without departing from the spirit and scope of the invention as claimed. Accordingly, the scope of the present invention is defined by the appended claims rather than the foregoing description of embodiment.

1. A system for managing a plurality of mobile devices, the system comprising:
a first server configured to establish a secure channel with a mobile device using a supplementary security domain (SSD) when a request to provision an application installed in the mobile device, wherein the mobile device includes a secure element already personalized via a trusted service manager with the SSD, the application distributed by a service provider is preinstalled in or downloaded into the mobile device, the first server obtains respective identifiers of the secure element and the application from the mobile device and updates the SSD; and
a hardware security module, coupled to the first server, configured to compute a new key set based on a key set of the SSD, wherein the first server is configured to interact with the hardware security module to retrieve the new key set so as to generate a new SSD for the secure element.

2. The system as recited claim 1, wherein the trusted service manager is to help a plurality of service providers distribute and manage contactless services for their customers and does not participate in actual transactions, and the first server is one of a plurality of servers that are operated and controlled by the service provider and involved in an actual transaction.

3. The system as recited claim 2, wherein the mobile device is near-field communication (NFC) device.

4. The system as recited claim 2, further comprising a second server, coupled to the first server, configured to prepare data arrays, wherein the first server receives the data array and causes the mobile device to receive the data array for provisioning the application.

5. The system as recited claim 4, wherein the data array is prepared in reference to the new SSD.

6. The system as recited claim 4, wherein the first server is configured to manage a life cycle of the secure element and one or more applets in the mobile device.

7. The system as recited claim 6, wherein the first server is configured to delete, lock or reactivate an applet related to the application in the mobile device.

8. The system as recited claim 7, wherein the application is related to monetary functions requiring a secure transaction via the first server.

9. A method for managing a plurality of mobile devices, the method comprising:
receiving a request in a first server from a mobile device to provision an application installed in the mobile device, wherein the mobile device includes a secure element already personalized via a trusted service manager with a supplementary security domain (SSD), wherein the application distributed by a service provider is preinstalled in or downloaded into the mobile device;
establishing a secure channel between the first server and the mobile device using the SSD in responding to the request, wherein the first server obtains respective identifiers of the secure element and the application from the mobile device and updates the SSD; and
retrieving a new set key from a hardware security module configured to generate the new set key from a key set of the SSD; and
determining an updated SSD based on the new set key so as to update the secure element with the updated SSD.

10. The method as recited in claim 9, wherein the trusted service manager is to help a plurality of service providers distribute and manage contactless services for their customers and does not participate in actual transactions, and the first server is one of a plurality of servers that are operated and controlled by the service provider and involved in an actual transaction.

11. The method as recited claim 10, further comprising prepare data arrays in a second server, wherein the first server receives the data array from the second server and causes the mobile device to receive the data array for provisioning the application.

12. The method as recited claim 11, wherein the data array is prepared in reference to the new SSD.

13. The method as recited claim 9, further comprising managing a life cycle of the secure element and one or more applets in the mobile device.

14. The method as recited claim 10, wherein the first server is configured to delete, lock or reactivate an applet related to the application in the mobile device.

15. The method as recited claim 14, wherein the application is related to monetary functions requiring a secure transaction via the first server.

16. The method as recited claim 9, wherein the new set key is only known to the service provider.
